(19) United States
(12) Patent Application Publication
(10) Pub. No.: US 2021/0212488 A1
(43) Pub. Date: Jul. 15, 2021

(54) OUTDOOR COOKING KIT, SYSTEM, AND METHOD THEREOF

(71) Applicant: North Atlantic Imports, LLC, Logan, UT (US)

(72) Inventors: James C. Bush, III, Providence, UT (US); Christopher L. Hanks, Logan, UT (US); James P. Miner, Preston, ID (US)

(21) Appl. No.: 17/143,880

(22) Filed: Jan. 7, 2021

Related U.S. Application Data
(60) Provisional application No. 62/958,946, filed on Jan. 9, 2020.

(51) Int. Cl. A47G 21/06; B26B 29/02; A47G 21/14

(52) U.S. Cl. CPC A47G 21/06; A47G 21/14; B26B 29/02

(57) ABSTRACT

Embodiments of an outdoor cooking kit and method of assembling the outdoor cooking kit are provided. The outdoor cooking kit includes a case, a flexible mat, one or more utensils, and a seasoning container. The case extends between first and second end portions with one or more extensions therebetween. The flexible mat may be manually moved to a rolled position to form an elongated rolled structure extending between first and second ends. The one or more utensils may be positioned within the rolled structure of the flexible mat, and the seasoning container may be positioned within the second end portion of the case. With this arrangement, the first and second ends of the rolled structure are positioned between the first and second end portions of the case and maintained with the one or more extensions being in a taut position.

### CROSS-REFERENCE TO RELATED APPLICATIONS

This application claims the benefit of U.S. Provisional Application No. 62/258,946, filed Jan. 9, 2020, the disclosure of which is hereby incorporated by reference herein in its entirety.

### TECHNICAL FIELD

The present invention relates generally to an outdoor cooking kit and, more specifically, the present invention relates to a system for assembling and maintaining the outdoor cooking kit in a compact manner.

### BACKGROUND

Eating in the outdoors away from home is an enjoyable past time. Many go to great lengths by going on day hikes, backpacking trips or even trips to the park to enjoy eating in the atmosphere of the outdoors. Getting the gear and tools for eating outdoors often can take time to locate and can be frustrating when some of the tools for eating outdoors are misplaced. Further, many desire to be prepared with the primary tools ready to go and handy for clean food preparation while eating in the outdoors.

### BRIEF SUMMARY OF THE INVENTION

The present invention is directed to various embodiments of an outdoor cooking kit and a method for assembling such outdoor cooking kit. In one embodiment, the outdoor cooking kit includes a case, a flexible mat, and one or more utensils. The case includes a first end portion and a second end portion with one or more stretchable extensions extending therebetween. The flexible mat is manually moveable between a rolled position and a flat position. The one or more utensils are sized and configured to be positioned within a bore of the flexible mat upon being in the rolled position. Upon the flexible mat being in the rolled position, the flexible mat is positionable between the first and second end portions with the one or more extensions in a taut position to maintain the flexible mat between the first and second end portions of the case.

In another embodiment, the outdoor cooking kit further includes a seasoning container sized and configured to be removably positioned within one of the first and second end portions of the case. In another embodiment, the seasoning container extends to define at least two inner spaces therein sized and configured to hold different seasonings in the at least two inner spaces. In another embodiment, the seasoning container includes a bottom wall and a top wall with a curved side wall therebetween, the bottom wall being removable to access the at least two inner spaces, the top wall extending to define a first pivotable lid and a second pivotable lid.

In another embodiment, the at least two extensions include a first extension and a second extension such that, upon the flexible mat being in the rolled position and being positioned between the first and second end portions, each of the first and second extensions extend along opposing sides of the flexible mat. In another embodiment, upon the flexible mat being in the rolled position and being positioned between the first and second end portions of the case, the case and flexible mat extend to define an elongated structure with a longitudinal axis extending along a length of the elongated structure. In still another embodiment, the elongated structure defines an opening such that the opening extends in at least one of the first and second end portions.

In another embodiment, the one or more utensils include a knife with a sheath. In another embodiment, the one or more utensils include a first knife and a second knife. In still another embodiment, the flexible mat extends as a flat structure defining a top surface extending to a periphery of the flat structure, the top surface defining a continuous channel therein such that the continuous channel extends adjacently along the periphery of the flat structure. In still another embodiment, the first and second end portions extend with a sleeve structure.

In accordance with another embodiment of the present invention, an outdoor cooking kit includes a case, a flexible flat mat, and one or more utensils. The case includes a first end portion and a second end portion with one or more stretchable extensions extending therebetween. The flexible flat mat is manually moveable to a rolled position so as to exhibit an elongated rolled structure extending between a first end and a second end. The one or more utensils are positionable within the elongated rolled structure of the flexible flat mat. With this arrangement, the first and second ends of the elongated rolled structure is positioned between the first and second end portions of the case and maintained with the one or more extensions being in a taut position.

In another embodiment, the outdoor cooking kit further includes a seasoning container, the seasoning container sized and configured to be positioned within the second end portion of the case and positioned adjacent the second end of the elongated rolled structure. In another embodiment, the at least two extensions include a first extension and a second extension such that the first and second extensions extend along opposing sides of the elongated rolled structure. In another embodiment, the one or more utensils include a knife.

In another embodiment, a method for assembling an outdoor cooking kit is provided. In one embodiment, the method includes the steps of: providing a case including a first end portion and a second end portion with one or more stretchable extensions therebetween; rolling a flexible flat mat with one or more utensils therewith to move the flexible mat to an elongated rolled structure extending between a first end and a second end; positioning the first end of the elongated rolled structure to be captured with the first end portion of the case; and positioning the second end portion of the case over the second end of elongated rolled structure such that the one or more extensions are in a taut position so that the first and second end portions of the case maintain the flexible flat mat in the elongated rolled position.

In another embodiment, the method further includes positioning a seasoning container to be captured by the second end portion of the case such that the seasoning container is positioned adjacent the second end of the elongated rolled structure. In another embodiment, the positioning the second end portion of the case over the second end of the elongated structure includes stretching the one or more extensions of the case to position the second end portion of the case over the second end of the elongated rolled structure.

In another embodiment, the providing step includes providing the first and second end portions of the case with a first sleeve structure and a second sleeve structure, respectively. In another embodiment, the providing step includes providing the first and second end portions of the case with a first cup structure and a second sleeve structure, respectively.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective view of an assembled outdoor cooking kit, according to an embodiment of the present invention;

FIG. 1A is a cross-sectional view of the assembled outdoor cooking kit, taken along section A-A of FIG. 1, depicting various components compacted within a case of the outdoor cooking kit, according to another embodiment of the present invention;

FIG. 1B is a cross-sectional view of only the case of the outdoor cooking kit, according to another embodiment of the present invention;

FIG. 2 is a perspective view of the outdoor cooking kit, in a disassembled position, depicting the outdoor cooking kit having a matt, one or more utensils and a seasoning container, according to another embodiment of the present invention;

FIG. 3 is a perspective view of the outdoor cooking kit, depicting a step for disassembling the outdoor cooking kit, according to another embodiment of the present invention;

and

FIG. 4 is a perspective view of a partially disassembled outdoor cooking kit, according to another embodiment of the present invention;

FIG. 5 is a rear perspective view of the seasoning container of FIG. 2, according to another embodiment of the present invention;

FIG. 6 is a front perspective view of the seasoning container, according to another embodiment of the present invention;

FIG. 6A is a cross-sectional view of the seasoning container, taken along section A-A of FIG. 6, according to another embodiment of the present invention;

FIG. 7 is a front perspective view of the seasoning container, depicting the container having a first lid moved to an open position, according to another embodiment of the present invention; and

FIG. 8 is a perspective view of the container with a lid insert detached from the container, according to another embodiment of the present invention.

### DETAILED DESCRIPTION OF THE INVENTION

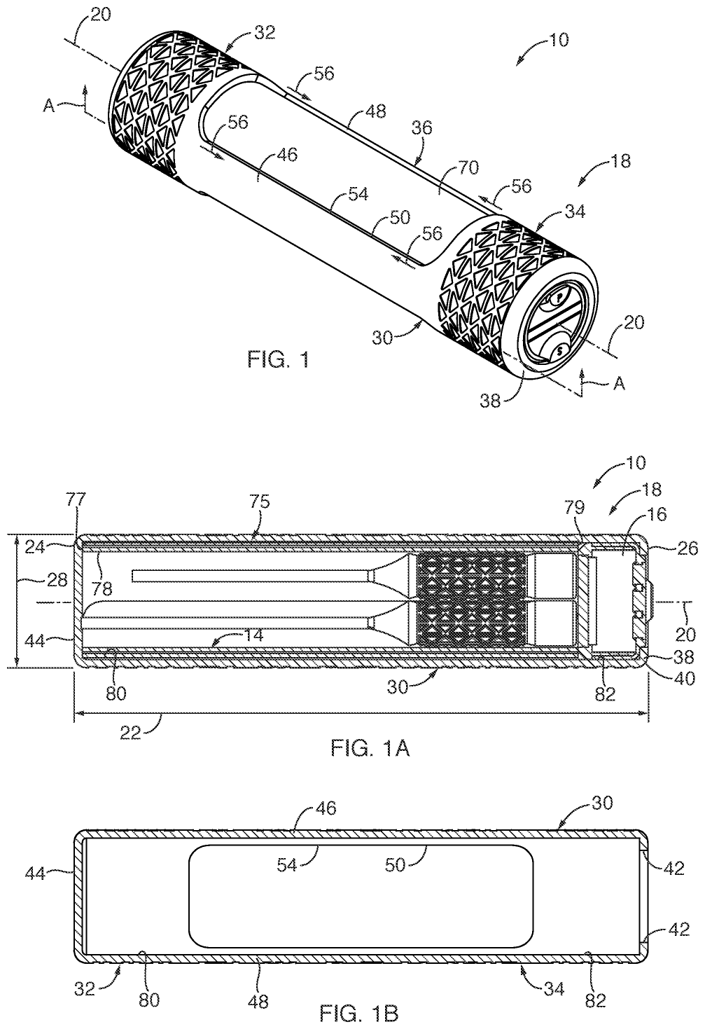

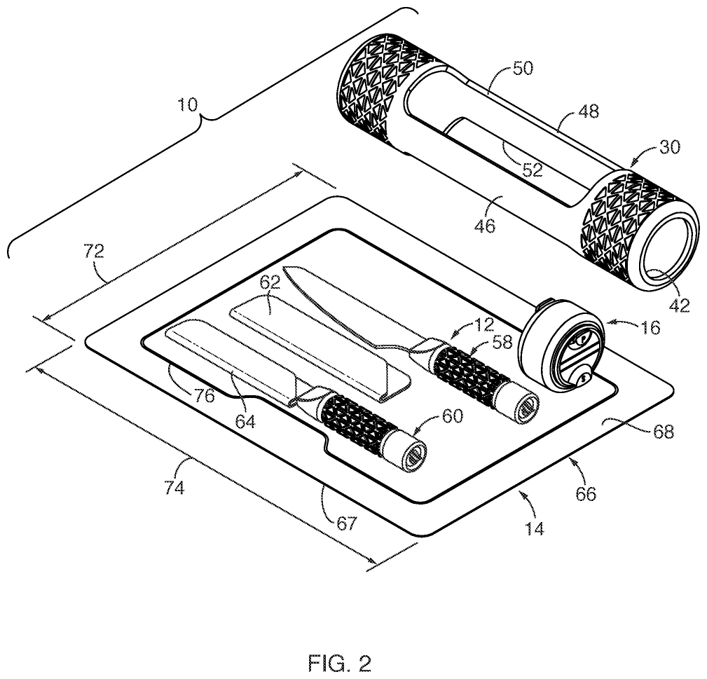

Referring to FIGS. 1 and 2, one embodiment of an outdoor cooking kit 10 that provides various components sized and configured to be moved between a compact, assembled position and a disassembled position is provided. In the assembled position, the outdoor cooking kit 10 may be highly compact so as to be readily storable in, for example, a backpack or any other storable location or carried in one's hand. Further, the outdoor cooking kit 10 may be readily disassembled to access various cooking components, such as one or more utensils 12, a flexible mat 14, and a seasoning container 16, as depicted in FIG. 2.

With reference to FIGS. 1, 1A, and 1B, the outdoor cooking kit 10, in its compact, assembled position, may exhibit an elongated structure 18 with a generally cylindrical shape. Such elongated structure 18 may define an axis 20 extending along a length 22, the length 22 extending between a first end 24 and a second end 26. Further, the elongated structure 18 may define a width or diameter 28 extending along the length 22 thereof. The outdoor cooking kit 10 may be maintained in its assembled position with a case 30. The case 30 may act as a shell with a first end portion 32 and an opposing second end portion 34, the first and second end portions 32, 34 connected with one or more extensions 36. The case 30 may be formed of a polymeric material, such as a rubber type material, with stretchable elastic characteristics.

In one embodiment, the first and second end portions 32, 34 may extend with a sleeve-like configuration. In another embodiment, the first and second end portions 32, 34 may extend with a cup-like configuration. In another embodiment, the first end portion 32 may extend with a cup-like configuration and the second end portion 34 may extend with a sleeve-like configuration. In another embodiment, the second end portion 34 may extend with a sleeve-like configuration with a lip 38 extending radially inward along an end periphery 40 of the second end 26 of the case 30 and/or the elongated structure 18. In another embodiment, the second end portion 34 includes an opening 42 defined in the second end 26 of the case 30 such that the opening 42 may be sized and configured to at least extend one's finger therethrough. In another embodiment, the opening 42 defined in the second end 26 of the case 30 may be axially aligned with the axis 20 of the case 30 and the elongated structure 18. In another embodiment, the first end 24 may extend to define a first end surface 44 and, the second end 26 may extend to define the radially extending lip 38.

As previously set forth, the case 30 includes one or more extensions 36 coupling the first end portion 32 to the second end portion 34. In one embodiment, the one or more extensions 36 may extend with a first extension 46 and a second extension 48. The first and second extensions 46, 48 may respectively extend between the first and second end portions 32, 34 on opposing lateral sides of the elongated structure 18. As such, the first and second extensions 46, 48 may define opposing first and second gaps 50, 52 in the case 30 such that each of the first and second gaps 50, 52 may partially be defined by an extension periphery 54 of the first and second extensions 46, 48 (see FIG. 2). Further, the first and second extensions 46, 48 may include a spring element so as to be stretchable. As such, the first and second extensions 46, 48 may elongate and be placed in tension, as depicted by arrow 56, so as to hold the various cooking components between the first and second end portions 32, 34 of the case 30 in a taut position such that the first and second end portions 32, 34 may be biased toward each other. In this manner, the first and second extensions 46, 48 may be sized to be in the taut position with the various cooking components supported within and between the first and second end portions 32, 34 of the case 30. As such, the case 30 may be sized and configured to maintain the various cooking components in the compact, assembled position.

Now with reference again to FIG. 2, as previously set forth, the outdoor cooking kit may be readily disassembled and may include the one or more utensils 12, the flexible mat 14 and the seasoning container 16. The one or more utensils 12 may be any type of eating or cooking utensil, such as, knives, forks, spoons or combination type utensils, for example, a spork (i.e., combined fork and spoon type utensil). In one embodiment, the one or more utensils 12 may be a first knife 58 and a second knife 60, each of which may include a protective sheath, such as a first sheath 62 and a second sheath 64. The first and second knife 58, 60 may each include typical knife components, such as, a blade and handle. The seasoning container 16, discussed in further detail herein, may be sized and configured to be positioned within the second end portion 34 of the case 30 and readily insertable into the second end portion 34 and readily removable therefrom.

The flexible mat 14 may extend with a flat structure with and generally square or rectangular shape, but may also exhibit other shapes. The flat structure 66 may define a periphery 67 and extend between a top surface 68 and a bottom surface 70 (FIG. 1). Further, the flat structure 66 may extend with a width 72 and a length 74. In one embodiment, the top surface 68 of the flexible mat 14 may define a continuous channel 76 set-back from the periphery 67 of the flexible mat 14, sized and configured to catch debris or liquid therein. The flexible mat 14 may be a polymeric material and may be manually manipulated to be moved to a rolled position and a flat position.

As depicted in FIGS. 1A, 2 and 4, from the flat position, the flexible mat 14 may be rolled-up with the one or more utensils 12 in the flexible mat 14 so that, in the rolled position, the flexible mat 14 may hold the one or more utensils 12 therein. In other words, the one or more utensils 12 may be positioned within a bore 78 defined by the flexible mat 14 in the rolled position. In the rolled position, the flexible mat 14 may exhibit an elongated rolled structure 75 extending between a first mat end 77 and a second mat end 79 to define the width 72 or length of the elongated rolled structure 75. Such width 72 may be a sufficient length to correspond with a space defined between the first and second end portions 32, 34 of the case 30. Further, the sufficient length may be sized and configured to be at least partially positioned within sleeve portions or captured by the first and second end portions 32, 34 of the case 30. With this arrangement, the first mat end 77 of the elongated rolled structure 75 of the flexible mat 14 may be sized and configured to be inserted into a first hollow portion 80 (see FIG. 1B) of the first end portion 32 of the case 30 so that the flexible mat 14 may be positioned between the first and second end portions 32, 34 of the case 30, as depicted in FIGS. 1 and 1A. Further, the elongated rolled structure 75 may extend longitudinally to define a mat axis 81 (FIG. 4), the mat axis 81 extending along the elongated length or width 72. Upon assembling the elongated rolled structure 75 with the case 30, as previous set forth, the mat axis of the elongated rolled structure may be co-axial with the axis 20 of the assembled outdoor cooking kit 10.

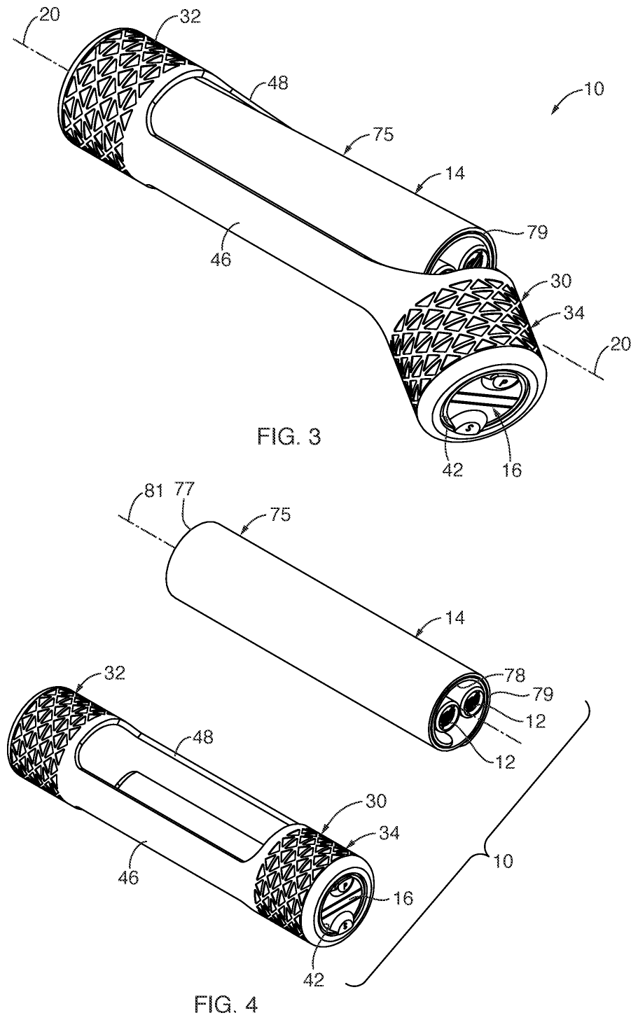

With reference to FIGS. 1, 2, 3 and 4, as previously set forth, the outdoor cooking kit 10 may be readily disassembled. For example, the second end portion 34 of the case 30 may be manually moved so that the second end portion 34 is off-set from the axis 20 of the outdoor cooking kit 10, as depicted in FIG. 3, so as to expose the second end 79 of the elongated rolled structure 75. Such may be employed due to the first and second extensions 46, 48 being stretchable, as previously set forth. Upon moving the second end portion 34 off-set from the axis 20, the rolled flexible mat 14 may be readily removed from the first end portion 32 of the case 30 so that the rolled flexible mat 14 may be completely removed from the case 30, as depicted in FIG. 4, leaving the first and second extensions 46, 48 of the case 30 in a relaxed, non-taut position. The flexible mat 14 may then be unrolled to the flat position, as depicted in FIG. 2, so that a user may access the one or more utensils 12, such as the first and second knives 58, 60. If desired, the seasoning container 16 may then be removed from a second hollow portion 82 (see FIGS. 1A and 1B) of the second end portion 34 of the case 30 by manually pushing the seasoning container 16 from or away the opening 42 of the second end portion 34 in the direction toward the first end portion 44 of the case 30. Similar to the disassembling process, the outdoor cooking kit 10 may be readily assembled by employing the reverse process steps of inserting the seasoning container 16 into the second hollow portion 82 of the second end portion 34 of the case 30, rolling the flexible mat 14 with the one or more utensils 12 therewith so that the flexible mat 14 is in the rolled position, inserting one end of the rolled flexible mat 14 into the first hollow portion 80 (see FIGS. 1A and 1B) of the first end portion 32 of the case 30, and stretching the second end portion 34 of the case 30 over an opposing second end of the rolled flexible mat 14 so that the rolled flexible mat 14 is positioned between the first and second end portions 32, 34 of the case 30, as depicted in FIG. 1.

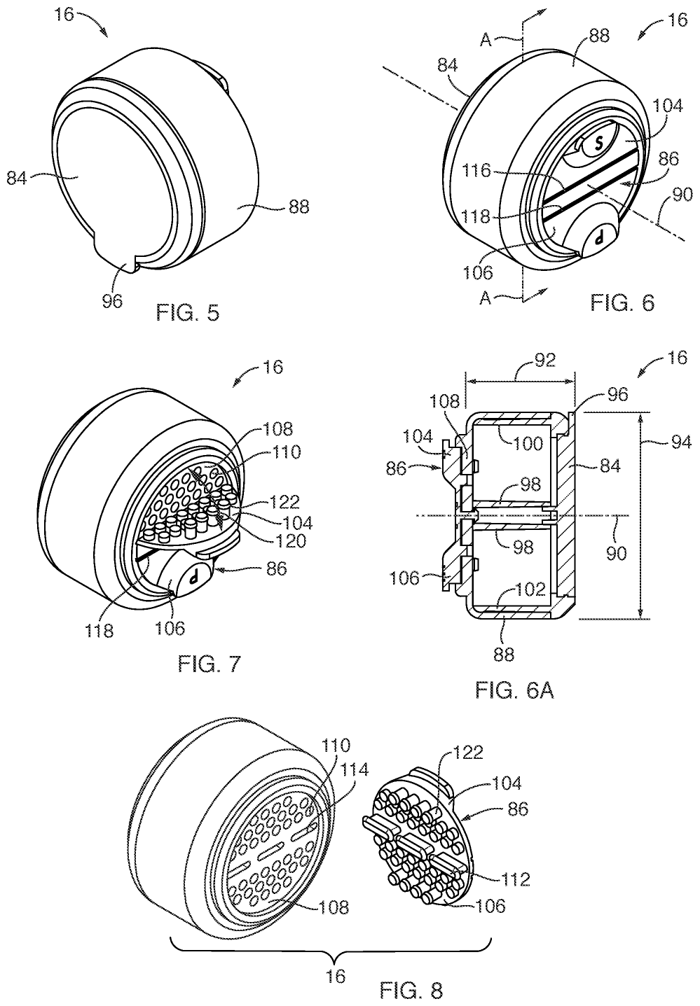

Now with reference to FIGS. 5, 6 and 6A, the seasoning container 16 will now be described. The seasoning container 16 may be a generally cylindrical structure sized and configured to be removably positioned within the second portion 34 of the case 30, as previously set forth (see FIG. 1). The container 16 may extend with a bottom wall 84 and a top wall 86 with a peripheral side wall 88 extending between the bottom and top walls 84, 86. The container 16 may extend to a container axis 90 extending along or parallel with a depth 92 of the container 16. Such container axis 90, upon the cooking kit 10 being assembled, may be co-axial with the axis 20 of the cooking kit 10 (see FIG. 1). The peripheral side wall 88 may extend with a radial curved surface, extending relative to and corresponding with the container axis 90. Further, the bottom and top walls 84, 86 may define a diameter 94 of the container 16 and may be oppositely positioned relative to each other. The bottom wall 84 may be removable relative to the peripheral side wall 88. Such bottom wall 84 may define a lip or tab 96 to facilitate manually removing the bottom wall 84 from the peripheral side wall 88 or container 16. Upon removing the bottom wall 84, an internal space of the container 16 may be accessed. The internal space may be partitioned with one or more dividers 98 to define a first internal space 100 and a second internal space 102.

Further, the top wall 86 may define first and second lids 104, 106 that may be pivoted outward to expose a top internal wall 108, the top internal wall 108 defining multiple apertures 110 therein (see FIG. 8). With this arrangement, the first internal space 100 may be at least partially defined by the side wall 88, the one or more dividers 98, the bottom wall 84, and the top wall 86. Similarly, the second internal space 102 may be at least partially defined by the side wall 88, the one or more dividers 98, the bottom wall 84 and the top wall 86. With this arrangement, the bottom wall 84 may be removed for accessing the first and second internal spaces 100, 102, the first and second internal spaces 100, 102 sized and configured for containing different types of seasonings, such as, salt in the first internal space 100 and pepper in the second internal space 102.

With reference to FIGS. 6A, 7 and 8, the seasoning container 16 may include additional structure employed for holding seasoning therein and for shaking small amounts out of the container 16 through the multiple apertures 110 for seasoning food. For example, the top wall 86 may be detachable from the top internal wall 108, but may be intended to be maintained in the attached position. Such top wall 86 may be attachable to the top internal wall 108 with, for example, wall tabs 112 extending from an underside of the top wall 86, the wall tabs 112 connectable to corresponding holes 114 defined in the top internal wall 108. Further, the top wall 86 may include the first and second lid 104, 106. Such first and second lids 104, 106 may be openable or pivotable with first and second channels 116, 118 (FIG. 6) defined in the top wall 86 such that the first and second lids 104, 106 may open so as to pivot about the respective first and second channels 116, 118, for example, as shown by arrow 120 relative to the first lid 104 (see FIG. 7). Further, the first and second lids 104, 106 may be maintained in respective closed positions with protrusions 122 sized to be held in the multiple apertures 110. Such protrusions 122 may be advantageous to keep seasoning from plugging the multiple apertures 110 defined in the top internal wall 108. With this arrangement, at least one of the first and second lids 104, 106 may be moved to the open position, to shake seasoning from the relative first and second internal spaces 100, 102.

With reference to FIGS. 1 and 2, as set forth herein, the outdoor cooking kit 10 provides various components sized and configured to be moved between a compact, assembled position and a disassembled position. Such assembled position of the outdoor cooking kit 10, depicted in FIG. 1, is highly compact and readily allows a user to transport and store the outdoor cooking kit 10 as desired. Further, as set forth herein, the outdoor cooking kit 10 can be readily disassembled for access to the one or more utensils 12, mat 14, and the seasoning container 16 for food preparation.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. An outdoor cooking kit, comprising:
a case including a first end portion and a second end portion with one or more stretchable extensions extending therebetween;
a flexible mat manually moveable between a rolled position and a flat position; and
one or more utensils, the one or more utensils sized and configured to be positioned within a bore of the flexible mat upon being in the rolled position;
wherein, upon the flexible mat being in the rolled position, the flexible mat is positionable between the first and second end portions with the one or more extensions in a taut position to maintain the flexible mat between the first and second end portions of the case.

2. The outdoor cooking kit of claim 1, further comprising a seasoning container sized and configured to be removably positioned within one of the first and second end portions of the case.

3. The outdoor cooking kit of claim 2, wherein the seasoning container extends to define at least two inner spaces therein sized and configured to hold different seasonings in the at least two inner spaces.

4. The outdoor cooking kit of claim 3, wherein the seasoning container comprises a bottom wall and a top wall with a curved side wall therebetween, the bottom wall being removable to access the at least two inner spaces, the top wall extending to define a first pivotable lid and a second pivotable lid.

5. The outdoor cooking kit of claim 1, wherein the at least two extensions comprise a first extension and a second extension such that, upon the flexible mat being in the rolled position and being positioned between the first and second end portions, each of the first and second extensions extend along opposing sides of the flexible mat.

6. The outdoor cooking kit of claim 1, wherein the one or more utensils comprise a knife with a sheath.

7. The outdoor cooking kit of claim 1, wherein the one or more utensils comprise a first knife and a second knife.

8. The outdoor cooking kit of claim 1, wherein the flexible mat extends as a flat structure defining a top surface extending to a periphery of the flat structure, the top surface defining a continuous channel therein such that the continuous channel extends adjacently along the periphery of the flat structure.

9. The outdoor cooking kit of claim 1, wherein the first and second end portions extend with a sleeve structure.

10. The outdoor cooking kit of claim 1, wherein, upon the flexible mat being in the rolled position and being positioned between the first and second end portions of the case, the case and flexible mat extend to define an elongated structure with a longitudinal axis extending along a length of the elongated structure.

11. The outdoor cooking kit of claim 11, wherein the elongated structure defines an opening such that the opening extends in at least one of the first and second end portions.

12. An outdoor cooking kit, comprising:
a case including a first end portion and a second end portion with one or more stretchable extensions extending therebetween;
a flexible flat mat manually moveable to a rolled position so as to exhibit an elongated rolled structure extending between a first end and a second end; and
one or more utensils, the one or more utensils positionable within the elongated rolled structure of the flexible flat mat;
wherein the first and second ends of the elongated rolled structure is positioned between the first and second end portions of the case and maintained with the one or more extensions being in a taut position.

13. The outdoor cooking kit of claim 12, further comprising a seasoning container, the seasoning container sized and configured to be positioned within the second end portion of the case and positioned adjacent the second end of the elongated rolled structure.

14. The outdoor cooking kit of claim 12, wherein the at least two extensions comprise a first extension and a second extension such that the first and second extensions extend along opposing sides of the elongated rolled structure.

15. The outdoor cooking kit of claim 12, wherein the one or more utensils comprises a knife.

16. A method for assembling an outdoor cooking kit, the method comprising:
providing a case including a first end portion and a second end portion with one or more stretchable extensions therebetween;
rolling a flexible flat mat with one or more utensils therewith to move the flexible mat to an elongated rolled structure extending between a first end and a second end;
positioning the first end of the elongated rolled structure to be captured with the first end portion of the case; and
positioning the second end portion of the case over the second end of elongated rolled structure such that the one or more extensions are in a taut position so that the first and second end portions of the case maintain the flexible flat mat in the elongated rolled position.

17. The method according to claim 16, further comprising positioning a seasoning container to be captured by the second end portion of the case such that the seasoning container is positioned adjacent the second end of the elongated rolled structure.

18. The method according to claim 16, wherein the providing comprises providing the first and second end portions of the case with a first sleeve structure and a second sleeve structure, respectively.

19. The method according to claim 16, wherein the providing comprises providing the first and second end portions of the case with a first cup structure and a second sleeve structure, respectively.

20. The method according to claim 16, wherein the positioning the second end portion of the case over the second end of the elongated structure comprises stretching the one or more extensions of the case to position the second end portion of the case over the second end of the elongated rolled structure.
